(19) United States
(12) Patent Application Publication
(10) Pub. No.: US 2026/0093385 A1
(43) Pub. Date: Apr. 2, 2026

(54) SYSTEMS, APPARATUSES, METHODS, AND COMPUTER PROGRAM PRODUCTS FOR EMBEDDED WHITEBOARD RETROSPECTIVES

(71) Applicant: ATLASSIAN PTY LTD, Sydney (AU)

(72) Inventors: Melanie Zhao, New York, NY (US); Patrick Little, Seattle, WA (US); Devin Clancy, Raleigh, NC (US); Corina Lawu, Foster City, CA (US); GT Deng, San Francisco, CA (US)

(21) Appl. No.: 18/902,413

(22) Filed: Sep. 30, 2024

(51) Int. Cl. G06F 3/0484; G06F 3/0481; G06F 40/186

(52) U.S. Cl. CPC G06F 3/0484; G06F 3/0481; G06F 40/186

(57) ABSTRACT

Systems, apparatuses, methods, and computer program products for embedded whiteboard retrospectives are provided. Examples of embedded whiteboard retrospectives are provided via user-accessed applications to one or more uses that may not have permissions to directly access embedded functionalities. An example apparatus is configured to receive a sprint retrospective creation request indication via a user device utilizing a user-accessed application; output, to the user device, a sprint retrospective template selection interface element comprising a whiteboard sprint retrospective template selection interface element associated with a whiteboard embedded functionality of an embedded application; receive, from the user device, a whiteboard sprint retrospective template selection indication; generate a whiteboard retrospective data object comprising whiteboard retrospective data and a plurality of whiteboard retrospective interface elements; and cause rendering of the plurality of whiteboard retrospective interface elements by the user-accessed application on the user device with a sprint whiteboard interface of the user-accessed application.

### BACKGROUND

Retrospectives are an essential in project management and product development lifecycles. For example, in the agile methodology, a sprint retrospective is a review conducted after a sprint that plays a key role, including assisting with determining what went well, where problems may have been had, and where area for improvement may exist. A retrospective occurs at or near the conclusion of a sprint to serve as an opportunity for collaborators to review and reflect on work performed.

Applicant has identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

Various embodiments described herein relate to apparatuses, systems, and methods for embedded whiteboard retrospectives.

In accordance with some embodiments of the present disclosure, an example apparatus is provided. The example apparatus includes at least one processor and at least one non-transitory memory including computer-coded instructions thereon, the computer coded instructions, with the at least one processor, configure the apparatus to: receive, from a user device associated with a user-accessed application, a sprint retrospective creation request indication; output, to the user device and in response to receiving the sprint retrospective creation request indication, a sprint retrospective template selection interface element comprising a sprint retrospective template option selection interface element associated with a whiteboard embedded functionality of an embedded application; receive, from the user device, a sprint retrospective template selection indication associated with the sprint retrospective template selection interface element associated with the whiteboard embedded functionality; generate, based on the sprint retrospective template selection indication, a whiteboard retrospective data object comprising whiteboard retrospective data and a plurality of whiteboard retrospective interface elements associated with the whiteboard retrospective data; and cause rendering of the plurality of whiteboard retrospective interface elements by the user-accessed application on the user device with a sprint whiteboard interface of the user-accessed application.

In some embodiments, the computer coded instructions are further configured to, with the at least one processor, cause the apparatus to: generate, prior to receiving the sprint retrospective creation request indication, a sprint completion summary interface element; cause rendering of the sprint completion summary interface element by the user-accessed application on the user device, wherein the sprint completion summary interface element comprises a sprint completion indication interface element; and wherein the sprint retrospective creation request indication is associated with detection of a user selection of the sprint completion indication interface element.

In some embodiments, the computer coded instructions are further configured to, with the at least one processor, cause the apparatus to: determine a set of users with permission to access the whiteboard retrospective data object; and output, synchronously to each user of the set of users and via a respective user device associated with the user-accessed application, a whiteboard retrospective indication interface element for rendering to a sprint interface.

In some embodiments, the computer coded instructions are further configured to, with the at least one processor, cause the apparatus to: receive, from the user device, a whiteboard retrospective update indication associated with an update to the whiteboard retrospective data; modify, based on the whiteboard retrospective update indication, the whiteboard retrospective data of the whiteboard retrospective data object with the update to the whiteboard retrospective data; and cause rendering of the plurality of whiteboard retrospective interface elements by the user-accessed application on the user device with the update to the whiteboard retrospective data.

In some embodiments, the computer coded instructions are further configured to, with the at least one processor, cause the apparatus to: cause rendering, synchronously and simultaneously to one or more of a set of users and via a respective user device associated with the user-accessed application, the plurality of whiteboard retrospective interface elements with the update to the whiteboard retrospective data.

In some embodiments, the sprint whiteboard interface is comprised of a whiteboard retrospective toolbar interface element comprised of a plurality of whiteboard retrospective tool interface elements.

In some embodiments, the computer coded instructions are further configured to, with the at least one processor, cause the apparatus to: receive, from the user device, a whiteboard retrospective toolbar interface element indication; and modify, based on the whiteboard retrospective toolbar interface element indication, the whiteboard retrospective data.

In accordance with some embodiments of the present disclosure, an example computer-implemented method is provided. The example computer-implemented method includes: receiving, from a user device associated with a user-accessed application, a sprint retrospective creation request indication; outputting, to the user device and in response to receiving the sprint retrospective creation request indication, a sprint retrospective template selection interface element comprising a sprint retrospective template option selection interface element associated with a whiteboard embedded functionality of an embedded application; receiving, from the user device, a sprint retrospective template selection indication associated with the sprint retrospective template selection interface element associated with the whiteboard embedded functionality; generating, based on the sprint retrospective template selection indication, a whiteboard retrospective data object comprising whiteboard retrospective data and a plurality of whiteboard retrospective interface elements associated with the whiteboard retrospective data, wherein the whiteboard retrospective interface elements include at least one whiteboard retrospective category interface element; and causing rendering of the plurality of whiteboard retrospective interface elements by the user-accessed application on the user device with a sprint whiteboard interface of the user-accessed application.

In some embodiments, the computer-implemented method further comprises: generating, prior to receiving the sprint retrospective creation request indication, a sprint completion summary interface element; causing rendering of the sprint completion summary interface element by the user-accessed application on the user device, wherein the sprint completion summary interface element comprises a sprint completion indication interface element; and wherein the sprint retrospective creation request indication is associated with detection of a user selection of the sprint completion indication interface element.

In some embodiments, the computer-implemented method further comprises: determining a set of users with permission to access the whiteboard retrospective data object; and outputting, synchronously to each user of the set of users and via a respective user device associated with the user-accessed application, a whiteboard retrospective indication interface element for rendering to a sprint interface.

In some embodiments, the computer-implemented method further comprises: receiving, from the user device, a whiteboard retrospective update indication associated with an update to the whiteboard retrospective data; modifying, based on the whiteboard retrospective update indication, the whiteboard retrospective data of the whiteboard retrospective data object with the update to the whiteboard retrospective data; and causing rendering of the plurality of whiteboard retrospective interface elements by the user-accessed application on the user device with the update to the whiteboard retrospective data.

In some embodiments, the computer-implemented method further comprises: causing rendering, synchronously and simultaneously to one or more of a set of users and via a respective user device associated with the user-accessed application, the plurality of whiteboard retrospective interface elements with the update to the whiteboard retrospective data.

In some embodiments, wherein the sprint whiteboard interface is comprised of a whiteboard retrospective toolbar interface element comprised of a plurality of whiteboard retrospective tool interface elements.

In some embodiments, the computer-implemented method further includes: receiving, from the user device, a whiteboard retrospective toolbar interface element indication; and modifying, based on the whiteboard retrospective toolbar interface element indication, the whiteboard retrospective data.

In accordance with some embodiments of the present disclosure, an example computer program product is provided. The example computer program product includes at least one non-transitory computer-readable storage medium having computer-readable program code portions stored therein, the computer-readable program code portions configured to: receive, from a user device associated with a user-accessed application, a sprint retrospective creation request indication; output, to the user device and in response to receiving the sprint retrospective creation request indication, a sprint retrospective template selection interface element comprising a sprint retrospective template option selection interface element associated with a whiteboard embedded functionality of an embedded application; receive, from the user device, a sprint retrospective template selection indication associated with the sprint retrospective template selection interface element associated with the whiteboard embedded functionality; generate, based on the sprint retrospective template selection indication, a whiteboard retrospective data object comprising whiteboard retrospective data and a plurality of whiteboard retrospective interface elements associated with the whiteboard retrospective data, wherein the whiteboard retrospective interface elements include a whiteboard retrospective toolbar interface element; and cause rendering of the plurality of whiteboard retrospective interface elements by the user-accessed application on the user device with a sprint whiteboard interface of the user-accessed application.

In some embodiments, the at least one non-transitory computer-readable storage medium having computer-readable program code portions stored therein, further configure the computer-readable program code portions to: generate, prior to receiving the sprint retrospective creation request indication, a sprint completion summary interface element; cause rendering of the sprint completion summary interface element by the user-accessed application on the user device, wherein the sprint completion summary interface element comprises a sprint completion indication interface element; and wherein the sprint retrospective creation request indication is associated with detection of a user selection of the sprint completion indication interface element.

In some embodiments, the at least one non-transitory computer-readable storage medium having computer-readable program code portions stored therein, further configure the computer-readable program code portions to: determine a set of users with permission to access the whiteboard retrospective data object; and output, synchronously to each user of the set of users and via a respective user device associated with the user-accessed application, a whiteboard retrospective indication interface element for rendering to a sprint interface.

In some embodiments, the at least one non-transitory computer-readable storage medium having computer-readable program code portions stored therein, further configure the computer-readable program code portions to: receive, from the user device, a whiteboard retrospective update indication associated with an update to the whiteboard retrospective data; modify, based on the whiteboard retrospective update indication, the whiteboard retrospective data of the whiteboard retrospective data object with the update to the whiteboard retrospective data; and cause rendering of the plurality of whiteboard retrospective interface elements by the user-accessed application on the user device with the update to the whiteboard retrospective data.

In some embodiments, the sprint whiteboard interface is comprised of a whiteboard retrospective toolbar interface element comprised of a plurality of whiteboard retrospective tool interface elements.

In some embodiments, the at least one non-transitory computer-readable storage medium having computer-readable program code portions stored therein, further configure the computer-readable program code portions to: receive, from the user device, a whiteboard retrospective toolbar interface element indication; and modify, based on the whiteboard retrospective toolbar interface element indication, the whiteboard retrospective data.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates a block diagram of a network and system architecture in accordance with one or more embodiments of the present disclosure;

FIG. 2 illustrates an example sprint completion summary interface element in accordance with one or more embodiments of the present disclosure;

FIG. 3 illustrates an example sprint retrospective template selection interface element in accordance with one or more embodiments of the present disclosure;

FIG. 4 illustrates an example whiteboard sprint retrospective template selection interface elements in accordance with one or more embodiments of the present disclosure;

FIG. 5 illustrates an example sprint whiteboard interface in accordance with one or more embodiments of the present disclosure;

FIG. 6 illustrates an example whiteboard retrospective verification interface element in accordance with one or more embodiments of the present disclosure;

FIG. 7A-7D illustrate flowcharts of operations performed by computing systems configured in accordance with one or more embodiments of the present disclosure; and

FIGS. 8A and 8B illustrate an examples of computing systems in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

### Overview

Various embodiments of the present disclosure address technical problems associated with generating collaborative retrospectives upon completion of software development sprints or other tasks. Retrospectives are used in project management and product development, including management of software development operations. Software applications that are configured to facilitate retrospective generating operations may be utilized on conclusion of a project or in the middle of a project to provide collaborators the ability to review and reflect on the work that has been performed. An example associated with Agile development is for one or more collaborators or users of a retrospective application after or during a sprint to determine and/or identify improvements for future sprints.

A retrospective application may capture informal, unstructured, and freeform data from individual users and teams to foster collaboration among users or collaborators for determining and identifying areas for continuous improvement. A retrospective application may also enhance team collaboration and problem-solving, including both for single members of a team and for all team members collectively. Various embodiments of the present disclosure provide for remote users to utilize a retrospective application collectively, including simultaneously.

An embedded retrospective application is an embedded application that may be accessed via a user-accessed application. The user-accessed application may be associated with a first set of user accounts specific to the user-accessed application. The embedded retrospective application may be associated with a first set of user accounts specific to the embedded retrospective application. Through using a user-accessed application, a user with a user account with the user-accessed application, may access the embedded retrospective application (or other embedded applications) without necessarily having previously created a user account specific to embedded retrospective application. In various embodiments, instead of not having a user account specific to embedded retrospective application, a user may not have a user account for the embedded retrospective application but may lack required permissions to access some or all of the embedded retrospective application. The user-accessed application may, among other things, allow users with user accounts having permissions for the user-accessed application to access an embedded retrospective application.

According to various embodiments, there is provided a system, apparatus, method, and/or a computer program for embedded whiteboard retrospectives. The present disclosure provides for generating and rendering a sprint whiteboard interface associated with whiteboard embedded functionality by a user using a user-accessed application. The sprint whiteboard interface may provide for multiple users utilizing the user-accessed application to either separately or collectively utilize a sprint whiteboard interface for conducting a sprint retrospective.

### Definitions

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

The terms “user device,” “computing device,” “client device,” “network device,” “computer,” “user equipment,” and similar terms may be used interchangeably to refer to computer hardware and/or software that is configured to access a service (e.g. a system management service). The service is often (but not always) on another computer system, in which case the user device accesses the service by way of a network. User devices may include, without limitation, smart phones, tablet computers, laptop computers, wearables, personal computers, enterprise computers, and the like.

The term “functionality” refers to one or more software-driven processes and/or operations that may be initiated via a particular application. In some embodiments, a functionality of a particular application is separated into full functionality provided to a first set of users and/or user accounts.

The term “service-oriented platform” refers to a complex network computing environment associated with a multitude of user devices, applications, services, and microservices. For example, in some embodiments, a service-oriented platform includes dozens of applications that are supported by multiple services operating within a cloud based platform. Service oriented platforms may include one or more applications that are configured to generate and update one or more repositories of collected information associated with each of the one or more applications. Such service-oriented platforms can support an application or multiple applications that are configured for the collection of information, in the form of data objects, to at least capture, classify, and structure such data objects. In some embodiments, one or more applications can receive and store information collected via another application.

The term “user-accessed application service” is used to refer to an application that may be executed (e.g., an executable code base) to perform a particular first set of functions associated with a user-accessed application configured to provide a second set of functions associated with an embedded application and/or a retrospective application through interaction with a connection associated with an embedded application service and/or a retrospective application service. Via such a connection, the user-accessed application enables a user to access functionality of the embedded application and/or the retrospective application without requiring a user to have a user account for the embedded application and/or the retrospective application. In various embodiments, the user-accessed application is associated with a first set of user accounts that are provisioned as user-accessed application user accounts to enable access to the functionality provided by the user-accessed application such that a user must authenticate a session associated with a user-accessed application user account before accessing functionality provided by the user-accessed application, including accessing the embedded application service and/or retrospective service.

The term “embedded application service” is used to refer to an embedded application that performs a particular second set of functions associated with being accessed at least through a user-facing application associated with a user-accessed application service that is separate from the embedded application service. An embedded application is associated with a second set of user accounts that are provisioned to enable access to the functionality provided by the embedded application, some of which are provisioned for accessing functionality of the user-accessed application as well such that a user must authenticate a session associated with a user-accessed application user account and an embedded application user account to access functionality of the embedded application from within a user-facing application associated with the user-accessed application service. In some embodiments, an embedded application is also accessible directly, which may include one or more additional and/or alternative functions being accessible through the embedded application when accessed directly rather through a user-accessed application. Thus, an embedded application service may communicate data directly with a user via their user device or through a user-accessed application service. An embedded application service may also communicate with one or more other services, including a retrospective application service.

As used herein, the term “retrospective application service” is used to refer to an embedded application that is specifically configured as a retrospective application that performs a particular third set of functions associated with being accessed at least through a user-facing application associated with a user-accessed application service that is separate from the retrospective application service. A retrospective service is associated with a third set of user accounts that are provisioned to enable access to the functionality provided by the retrospective application, some of which are provisioned for accessing functionality of the user-accessed application as well such that a user must authenticate a session associated with a user-accessed application user account and a retrospective application user account to access functionality of the retrospective application from within a user-facing application associated with the user-accessed application service. In some embodiments, a retrospective application is also accessible directly, which may include one or more additional and/or alternative functions being accessible through the embedded application when accessed directly rather through a user-accessed application. Thus, a retrospective application service may communicate data directly with a user via their user device or through a user-accessed application service. A retrospective application service may also communicate with one or more other services, including an embedded application service.

As used herein, the term “embedded application” is used to refer to application that may be executed (e.g., an executable code base) that performs a particular second set of functions and is configured to be accessed at least through a user-facing application associated with a user-accessed application separate from the embedded application. An embedded application is associated with a second set of user accounts that are provisioned to enable access to the functionality provided by the embedded application, some of which are provisioned for accessing functionality of the user-accessed application as well such that a user must authenticate a session associated with a user-account provisioned as a user-accessed app user account and an embedded app user account to access functionality of the embedded application from within a user-facing application associated with the user-accessed application.

As used herein, the term “whiteboard embedded functionality” is used to refer to functionality of one or more embedded applications that are associated with the generation, storage, modification, and usage or rendering of a sprint whiteboard interface, sprint whiteboard data object, and/or sprint whiteboard data, which are described herein.

A “data object” refers to electronically managed data that is computer readable and computer transmittable and represents information maintained by an application. A data object includes data utilized for any of a myriad of functions provided by an application, including metadata associated with the data object.

As used herein, the term “whiteboard retrospective data object” is used to refer to a collection of data relating to a whiteboard retrospective. In some embodiments, the whiteboard retrospective data object is comprised of whiteboard retrospective data and whiteboard retrospective interface elements. Types of whiteboard retrospective data and whiteboard retrospective interface elements are described herein. The whiteboard retrospective data object is generated by a retrospective application service and may be displayed by a user-accessed application via a user-accessed application service.

As used herein, the term “whiteboard retrospective data” is used to refer to computer readable and computer transmittable data regarding a whiteboard retrospective. Such data may include, without limitation, information relating to whiteboard metadata, whiteboard status, whiteboard users, and other data necessary for the proper function of the whiteboard embedded functionality. Types of whiteboard retrospective data are described herein. The whiteboard retrospective data is included in a whiteboard retrospective data object generated by a retrospective application service. The whiteboard retrospective data may be generated by a retrospective application service or may be received by the retrospective application service from a user-accessed application service or an embedded application service, which may then be included in a whiteboard retrospective data object as whiteboard retrospective data.

As used herein, the term “page retrospective data object” is used to refer to a collection of data relating to a page retrospective. In some embodiments, the page retrospective data object is comprised of page retrospective data arranged according to a linear formatting of associated interface elements.

As used herein, the term “page retrospective data” is used to refer to computer readable and computer transmittable data regarding a whiteboard retrospective. Such data may include, without limitation, information relating to whiteboard metadata, whiteboard status, whiteboard retrospective tool interface elements (such as lines, shapes, colors, markup, text, sticky notes, icons, images, and charts), whiteboard users, and other data necessary for the proper function of the whiteboard retrospective.

As used herein, the term “interface” is used to refer to a graphical user interface. An interface may be rendered on a user device, such as via a user-accessed application. An interface may include one or more interface elements that are rendered on the interface.

As used herein, the term “interface element” is used to refer to an element of a graphical user interface that may be rendered on a display of a user device, such as with display of a user device and via a user-accessed application. The term “interface element” is used herein as part of longer terms to identify specific interface elements. These specific, and distinct, interface elements are unique, and it will be appreciated should not be interpreted to be the same unless expressly described as such herein.

As used herein, the term “indication” is used to refer to a transmission of data from one service to another service, such as from a user-accessed application on a user device to an embedded application service and/or a retrospective application service. The data transmission is associated with an action or selection taken by a user via the user-accessed application and indicates the action or selection taken. The term “indication” is used herein as part of longer terms to identify specific indications. These specific, and distinct, indications are unique, and it will be appreciated should not be interpreted to be the same unless expressly described as such herein.

### Exemplary Systems, Methods, and Computer Program Products

Embodiments of the present disclosure herein include systems and apparatuses for facilitating sprint retrospectives described herein may be implemented in various embodiments.

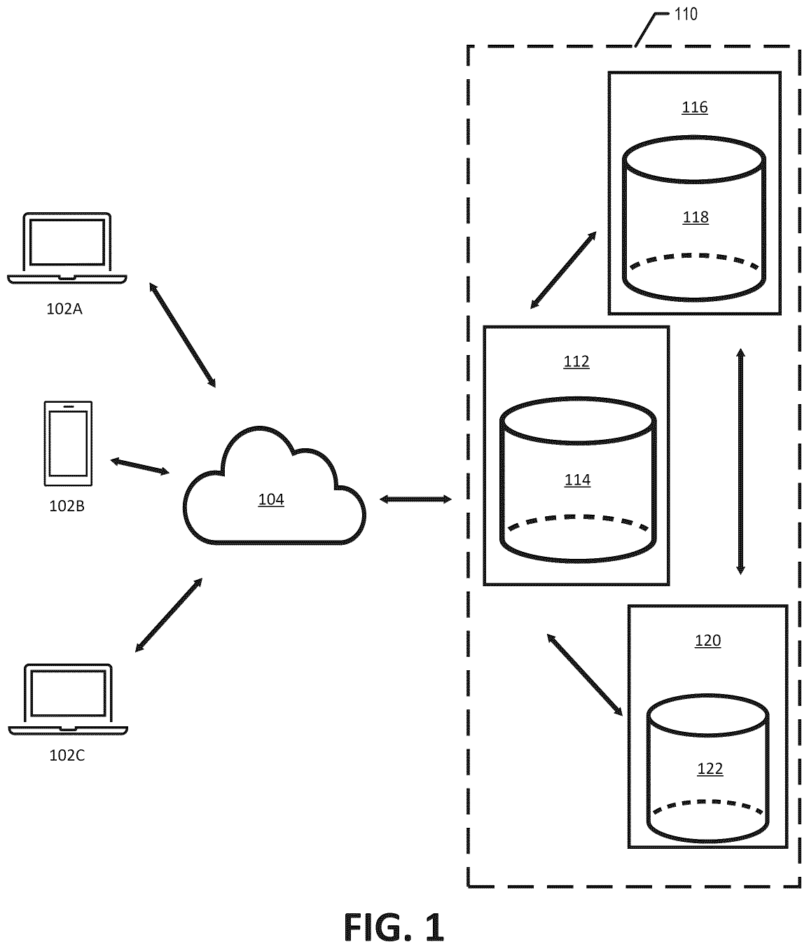

FIG. 1 illustrates a block diagram of a network and system architecture in accordance with one or more embodiments of the present disclosure. A network and system architecture may include one or more user devices 102, a network 104, and service-oriented platform 110. The one or more user devices 102 are connected to the service-oriented platform 110 through the network 104. In various embodiments, the service-oriented platform 110 may include one or more services and/or one or more data repositories. A service may be associated with a unique data repository or may be associated with a data repository shared with another service.

In the embodiment illustrated in FIG. 1, the service-oriented platform 110 includes a user-accessed application service 112, a user-accessed application data repository 114, an embedded application service 116, an embedded application data repository 118, a retrospective application service 120, and a retrospective application data repository 122.

In various embodiments, the user-accessed application service 112 may communicate with the user-accessed application data repository 114 to store, retrieve, and modify data stored in the user-accessed application data repository 114. In various embodiments, the user-accessed application service 112 may also communicate with one or more other services and/or data repositories associated with those services.

In various embodiments, the embedded application service 116 may communicate with the embedded application data repository 118 to store, retrieve, and modify data stored in the embedded application data repository 118. In various embodiments, the embedded application service 116 may also communicate with one or more other services and/or data repositories associated with those services.

In various embodiments, the retrospective application service 120 may communicate with the user-accessed application data repository 114 to store, retrieve, and modify data stored in the retrospective application data repository 122. In various embodiments, the retrospective application service 120 may also communicate with one or more other services and/or data repositories associated with those services.

In various embodiments, a user device 102 may communicate over the network 104 with one or more services of the service-oriented platform 110 via the user-accessed application service 112. In this manner, a user may access the services of the service-oriented platform 110 through the user-accessed application service 112. In various embodiments, one or more applications of the service-oriented platform 110 may generate and caused to be rendered one or more interfaces and/or interface elements on a user device 102 via a user-accessed application 112.

In various embodiments, the user-accessed application 112 may be stored, executed, and run on a user device 102. The user-accessed application 112 may store data in, retrieve data from, and modify data in the user-accessed application data repository 114. The user-accessed application 112 is configured to communicate with embedded application 116 and retrospective application service 120, which may each transmit data to a user device 102 by way of the user-accessed application 112.

In various embodiments, a user device 102 may allow a user to log into their user account associated with the user-accessed application of the user-accessed application service 112. Once logged in, the user device 102 may allow the user to access one or more interfaces of a user-accessed application that are rendered on the user device 102 to displaying one or more data or interface elements associated with a retrospective, such as described herein. The data and/or user interface elements may be based on data stored on one or more data repositories of the service-oriented platform 110.

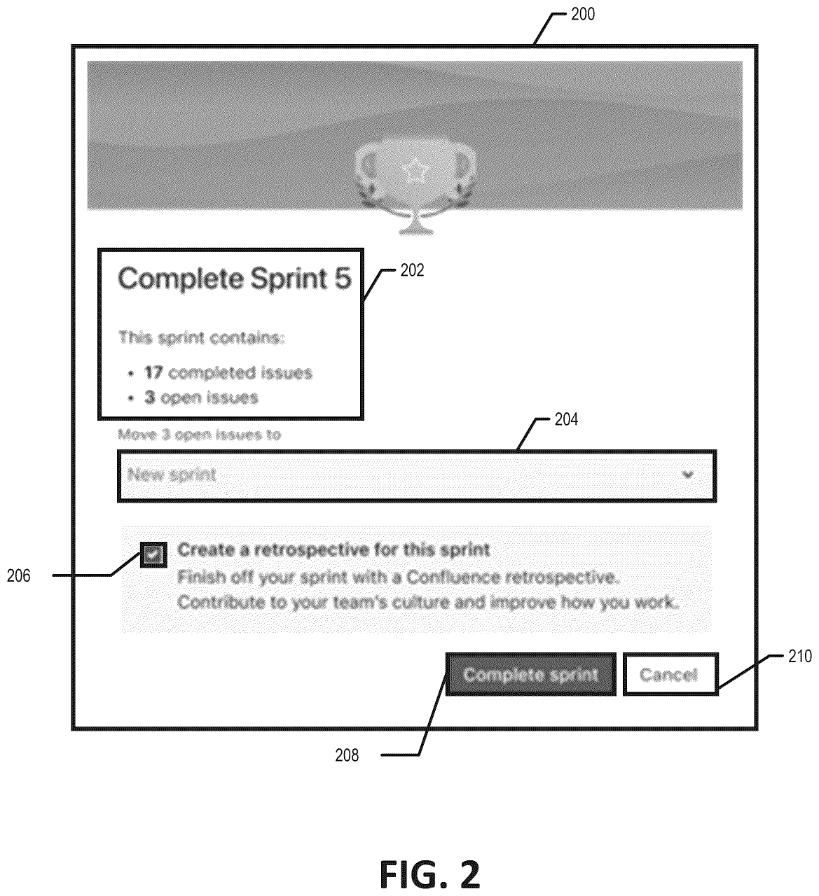

FIG. 2 illustrates an example sprint completion summary interface element in accordance with one or more embodiments of the present disclosure. In various embodiments, a sprint completion summary interface element 200 may include a sprint summary interface element 202, sprint association selection interface element 204, sprint summary retrospective interface element 206, sprint completion indication interface element 208, and sprint completion cancellation interface element 210. In various embodiments, a user-accessed application may render the sprint completion summary interface element 200 over one or more portions of a sprint interface rendered on a user device 102. Alternatively, in various embodiments, a user-accessed application may render the sprint completion summary interface element 200 as an interface rendered on a user device 102.

In various embodiments, the user-accessed application service 112 and/or embedded application service 116 may provide one or more functions associated with completing a sprint. Examples of such a sprint include completing tasks or issues associated with developing software. An indication of completion of the sprint may be received by the user-accessed application service 112 and/or embedded application service 116. In various embodiments, the indication of the completion of the sprint may be received from a user device 102 via the user-accessed application, such as when a user selects one or more user interface elements associated with the completion of a sprint. On receiving the indication of completion of the sprint, the service-oriented platform 110 may generate and cause to the be rendered on the user device 102 the sprint completion summary interface component 200 via the user-accessed application service 112.

Each of the interface elements of the sprint completion summary interface 200 may be associated with displaying data from a data repository of the service-oriented platform 110 and/or generating an indication.

A sprint summary interface element 202, when rendered, provides a summary of data associated with the sprint. In various embodiments, when generating the sprint completion summary interface component 200, the service-oriented platform 110 may receive data from one or more data repositories associated with the sprint. For example, a sprint may include multiple tasks that are to be complete by members of a team associated with the sprint. As the tasks are completed, one or more data may be stored in one or more of the data repositories (e.g., 114, 116, 122), such as in data objects, that are associated with the tasks and/or sprint. In various embodiments, such data include a sprint identifier (e.g., Sprint 5), a number of tasks to be performed in the sprint, a description of the task, a status of the task (e.g., open, complete, or the like), a user and/or team associated with the task, a locator to where additional data associated with the task is stored, and the like. In various embodiments, the sprint summary interface element 202 may be generated and rendered to display the sprint identifier and a number of tasks with each of the different statuses (e.g., number of completed issues, number of open issues).

A sprint association selection interface element 204, when rendered, provides a display of one or more user options for associating one or more portions of a sprint with another sprint. For example, the sprint association selection interface element 204 may be generated and rendered to provide a user with an interface to select one or more other sprint identifiers from a drop down box. In various embodiments, one or more portions of a sprint may be associated with a status that is other than completed. The user-accessed application service 112 may allow a selection by the user to provide via the user-accessed application service 112 how the non-completed portions of the sprint may be associated with, moved to, or assigned to another sprint. In various embodiments, if a user makes a selection, on selection of the sprint completion indication interface element 208 of the user-accessed application service 112 by the user will generate one or more association data objects transmitted to one or more data repositories of the service oriented platform that will be updated or modified to store the new association, movement, or assignment associated with the user indication.

A sprint summary retrospective interface element 206, when rendered, provides a display of one or more user options for creating a retrospective that are associated with the creation of a sprint retrospective creation request indication. For example, the sprint summary retrospective interface element 206 may be generated and rendered to provide a user with an interface to select that a user desires that a retrospective associated with a sprint be created. In various embodiments, if a user makes a selection to create a retrospective, on selection of the sprint completion indication interface element 208 of the user-accessed application service 112 by the user will generate one or more data objects transmitted to, among other things, the retrospective application service 120 to indicate a retrospective is to be created.

A sprint completion indication interface element 208, when rendered, provides a display of the interactive interface element to allow for a user interaction (e.g., a click or tap) associated with the user's selection to complete the sprint. In various embodiments, if a user makes a selection via an interaction with the user-accessed application 112 to complete the sprint, the interaction with the sprint completion indication interface element 208 of the user-accessed application service 112 by the user will generate a sprint completion indication that is transmitted to the service oriented platform 110. For example, the sprint completion indication may be transmitted to, among other things, the retrospective application service 120 when an indication for a retrospective to be created has been selected via a user interaction with the sprint summary retrospective interface element 206.

A sprint completion cancellation interface element 210, when rendered, provides a display of the interactive interface element to allow for a user interaction (e.g., a click or tap) associated with the user indicating that the sprint is not complete. In various embodiments, receiving an indication via the sprint completion cancellation interface element 210 may also close the sprint completion summary interface component 200 or otherwise remove it from an interface displayed on a user device 102. In various embodiments, this may cause a user-accessed application to return to a previous interface.

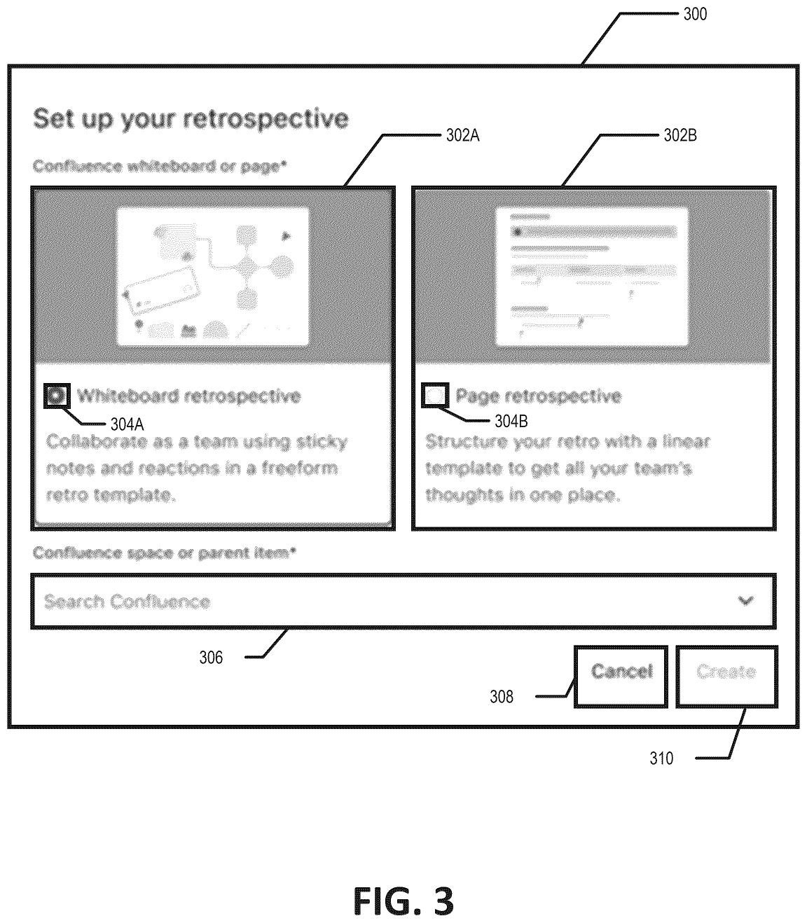

FIG. 3 illustrates an example sprint retrospective template selection interface element in accordance with one or more embodiments of the present disclosure. In various embodiments, a sprint retrospective template selection interface element 300 may include one or more sprint retrospective template option interface element 302 (e.g., 302A, 302B), one or more sprint retrospective template option selection interface element 304 (e.g., 304A, 304B), a sprint retrospective selection interface element 306, a sprint retrospective cancellation interface element 308, and a sprint retrospective creation interface element 310. In various embodiments, a user-accessed application may render the sprint retrospective template selection interface element 300 over one or more portions of a sprint interface rendered on a user device 102. Alternatively, in various embodiments, a user-accessed application may render the sprint retrospective template selection interface element 300 as an interface rendered on a user device 102.

The sprint retrospective template selection interface element 300 may be generated by a service of the service-oriented platform 110 and rendered on the user device 102 via a user accessed application. In various embodiments, the sprint retrospective template selection interface element 300 may be generated and rendered in response to receiving a user indication generated by a selection of a sprint completion indication interface element 208.

One or more sprint retrospective template option interface element 302, when rendered, provides a display of one or more user options for creating a retrospective sprint. In various embodiments, there may be a first sprint retrospective template option interface element 302A and a second sprint retrospective template option interface element 302B. The first sprint retrospective template option interface element 302A may be associated with a whiteboard retrospective template of a freeform retrospective template. The second sprint retrospective template option interface element 302B may be associated with a page retrospective of a linear template.

Each of the sprint retrospective template option interface element 302 may include a sprint retrospective template option selection interface element 304. A sprint retrospective template option selection interface element 304, when rendered, provides a display of the interactive interface element to allow for a user interaction (e.g., a click or tap) to select a sprint retrospective template option selection interface element 304 (e.g., by selecting a radio button).

In various embodiments, if a user makes a selection via a sprint retrospective template option selection interface element 304 (e.g., 304A, 304B), on selection of a sprint retrospective creation interface element 310 of the user-accessed application service 112 by the user will generate one or more retrospective template selection data objects transmitted to the retrospective application service 120. For example, the retrospective application service 120, on receiving a retrospective template selection data associated with a user indication of a first sprint retrospective template option selection interface element 304A will generate a whiteboard sprint retrospective template selection interface element 400 that will be transmitted to the user device 102 by the user-accessed application service 112 for rendering to the user.

In various embodiments, a user selection of a first sprint retrospective template option selection interface element 304A is associated with a whiteboard sprint retrospective to indicates a user's desire for a whiteboard sprint retrospective.

In various embodiments, a user selection of a second sprint retrospective template option selection interface element 304B is associated with a whiteboard sprint retrospective to indicates a user's desire for a page sprint retrospective.

A sprint retrospective selection interface element 306, when rendered, provides a display of one or more user options for where to create or store a whiteboard sprint data object. For example, sprint retrospective selection interface element 306 may be generated and rendered to provide a user with an interface to select one or more locations from a drop down box. The user-accessed application service 112 may allow a selection by the user to provide via the user-accessed application service 112 where to store and/or save a whiteboard retrospective data object that will be created.

A sprint retrospective cancellation interface element 308, when rendered, provides a display of the interactive interface element to allow for a user interaction (e.g., a click or tap) associated with the user indicating that the sprint retrospective should not be created. In various embodiments, receiving an indication via the sprint retrospective cancellation interface element 308 may also close the sprint retrospective template selection interface element 300 or otherwise remove it from an interface displayed on a user device 102. In various embodiments, this may cause a user-accessed application to return to a previous interface.

A sprint retrospective creation interface element 310, when rendered, provides a display of the interactive interface element to allow for a user interaction (e.g., a click or tap) associated with the user's selection to create a retrospective.

In various embodiments, if a user makes a selection via an interaction with a sprint retrospective creation interface element 310 in the user-accessed application 112 to create a retrospective while also selecting a first sprint retrospective template option selection interface element 304A associated with a whiteboard retrospective, the interaction of the selection via the sprint retrospective creation interface element 310 of the user-accessed application service 112 by the user will generate a sprint retrospective template selection indication that is transmitted to the service oriented platform 110. For example, the sprint retrospective template selection indication may be transmitted to, among other things, the retrospective application service 120. The retrospective service 120 may, in response to the retrospective template selection indication, generate a whiteboard retrospective data object comprising whiteboard retrospective data. In various embodiments, the whiteboard retrospective data may include, among other things, data associated with the sprint. The whiteboard data object may be generated and/or stored at the location selected by the user via sprint retrospective selection interface element 306.

In various embodiments, if a user makes a selection via an interaction with a sprint retrospective creation interface element 310 in the user-accessed application 112 to create a retrospective while also selecting a second sprint retrospective template option selection interface element 304B associated with a page retrospective, the interaction of the selection via the sprint retrospective creation interface element 310 of the user-accessed application service 112 by the user will generate a sprint retrospective template selection indication that is transmitted to the service oriented platform 110. For example, the sprint retrospective template selection indication may be transmitted to, among other things, the retrospective application service 120. The retrospective service 120 may, in response to the retrospective template selection indication, generate a page retrospective data object comprising page retrospective data. The page retrospective data object may be generated and/or stored at the location selected by the user via sprint retrospective selection interface element 306.

In generating the whiteboard retrospective data object, the retrospective service 120 may communicate with the user-accessed application service 112, including user-accessed application data repository 114, and the embedded application service 116, including the embedded application data repository 118, to receive sprint data. The sprint data received may be used in the generating of the whiteboard retrospective data object by using, formatting, or converting the sprint data to whiteboard retrospective data. For example, the user-accessed application service 112 may provide sprint data about one or more team members of the sprint (e.g., team member identifier(s)) that may be converted to whiteboard retrospective data, including associating the whiteboard retrospective data object with one or more user accounts associated with the one or more team members. As another example, the embedded application service 116 may provide sprint data about one or more tasks in the sprint (e.g., task identifier) that may be converted to whiteboard retrospective data, including associating the whiteboard retrospective data object with one or more retrospective tasks or retrospective identifiers associated with the tasks in the sprint.

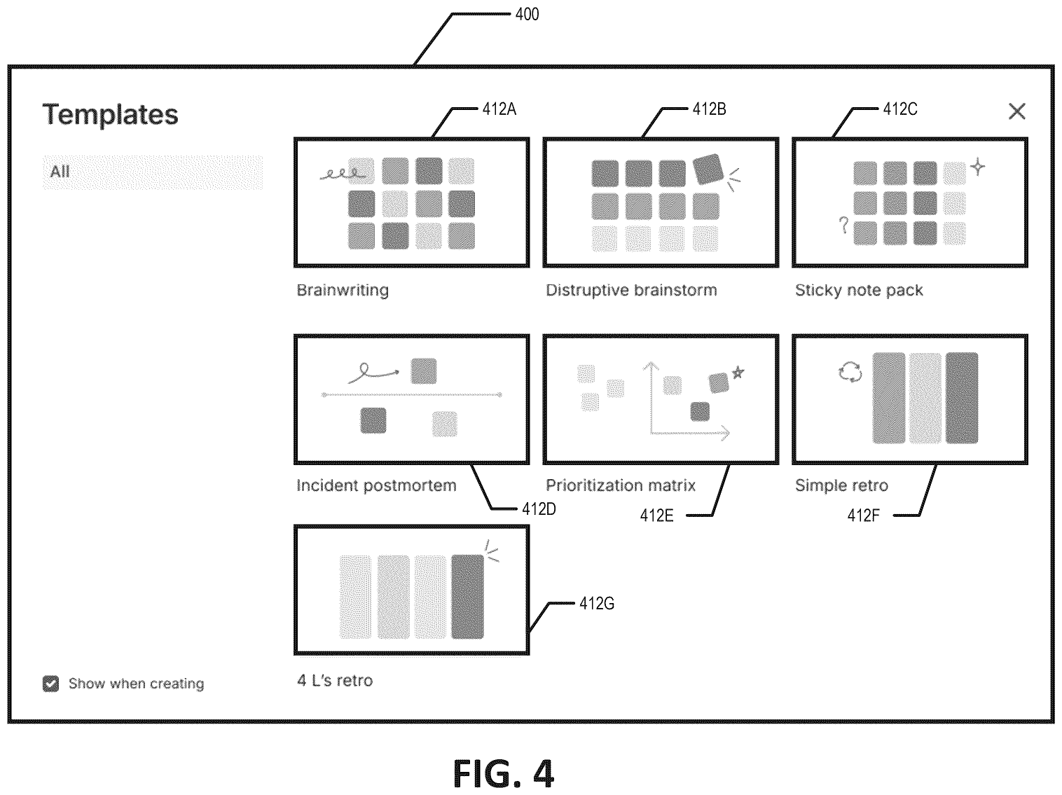

FIG. 4 illustrates an example whiteboard sprint retrospective template selection interface element in accordance with one or more embodiments of the present disclosure. In various embodiments, prior to generating a whiteboard retrospective data object, a user may be presented with a whiteboard sprint retrospective template selection interface element 400 to allow a user to select a template for the whiteboard retrospective. A template for the whiteboard retrospective may add one or more whiteboard template data to a whiteboard data object, such as data regarding organization or association of other whiteboard retrospective data.

A whiteboard sprint retrospective template selection interface element 400 may include one or more whiteboard retrospective template selection element 412 (e.g., 412A-412G). In various embodiments, a user-accessed application may render the whiteboard sprint retrospective template selection interface element 400 over one or more portions of a sprint interface rendered on a user device 102. Alternatively, in various embodiments, a user-accessed application may render the whiteboard sprint retrospective template selection interface element 400 as an interface rendered on a user device 102.

The whiteboard sprint retrospective template selection interface element 400 may be generated by a service of the service-oriented platform 110 and rendered on the user device 102 via a user accessed application. In various embodiments, the whiteboard sprint retrospective template selection interface element 400 may be generated and rendered in response receiving a sprint retrospective template selection indication generated by user's interaction with a sprint retrospective creation interface element 310.

A whiteboard retrospective template selection element 412 may be associated with a template structure that provides for one or more whiteboard retrospective data associated with different interface elements for displaying whiteboard retrospective data.

A first whiteboard retrospective template selection element 412A may be associated with a brainwriting template. A brainwriting template may be configured to enable users to problem solve via multiple rounds of individual brainstorming followed by a group discussion.

A second whiteboard retrospective template selection element 412B may be associated with a disruptive brainstorm template. A disruptive brainstorm template may be configured to enable users to foster creative thinking by introducing constraints to a brainstorming session.

A third whiteboard retrospective template selection element 412C may be associated with sticky note pack template. A sticky note pack template may be configured to enable users to quickly connect and share ideas.

A fourth whiteboard retrospective template selection element 412D may be associated with incident postmortem template. An incident postmortem template may be configured to enable users to organize and analyze the details of an incident or problem.

A fifth whiteboard retrospective template selection element 412E may be associated with prioritization matrix template. A prioritization matrix template may be configured to enable users to share goals and prioritize tasks.

A sixth whiteboard retrospective template selection element 412F may be associated with simple retrospective template. A simple retrospective template may be configured to enable users to quickly reflect on actions and identify ways to improve.

A seventh whiteboard retrospective template selection element 412G may be associated with 4 L's retrospective template. A 4 L's retrospective template may be configured to enable users to categorize thoughts and feelings. The 4 L's may be “loved”, “longed for”, “loathed”, or “learned”.

Each whiteboard retrospective template selection element 412, when rendered, provides a display of the interactive interface element to allow for a user interaction (e.g., a click or tap) associated with the user's selection of a whiteboard sprint retrospective template. In various embodiments, if a user makes a selection via an interaction with a whiteboard retrospective template selection element 412 in the user-accessed application 112, when the whiteboard retrospective data object is generated, it will include whiteboard retrospective data that includes whiteboard retrospective template data.

In various embodiments, on receiving the sprint retrospective template selection indication) associated with sprint retrospective creation interface element 310, the retrospective application service 120 generates interface element 400 and transmit it to the user-accessed application 112 to be rendered on the client device. Interface element 400 enables a user to further specify and customize the creation of a whiteboard sprint retrospective by offering a plurality of whiteboard sprint retrospective templates via selection of a whiteboard retrospective template selection element 412. A user may select a whiteboard retrospective template selection element 412 to indicate desire to create a whiteboard sprint retrospective using a selected template. If a user has indicated desire to create a whiteboard sprint retrospective from a selected template by selecting any whiteboard retrospective template selection element 412, the whiteboard retrospective data object is generated with whiteboard retrospective data that includes whiteboard retrospective template data.

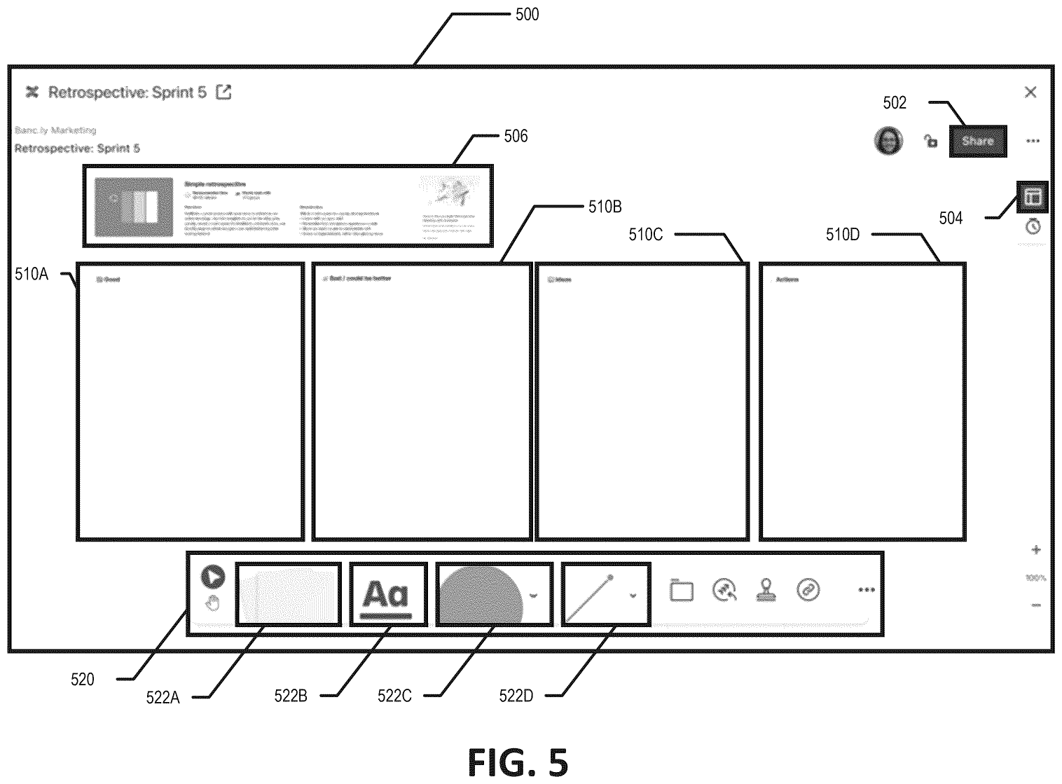

FIG. 5 illustrates an example sprint whiteboard interface in accordance with one or more embodiments of the present disclosure. A sprint whiteboard interface 500 may include multiple whiteboard retrospective interface elements, which may include whiteboard retrospective distribution interface element 502, whiteboard retrospective template display options interface element 504, whiteboard retrospective template description interface element 506, whiteboard retrospective category interface element 510, whiteboard retrospective toolbar interface element 520, and whiteboard retrospective toolbar interface elements 522. In various embodiments, the whiteboard retrospective interface elements displayed may display and be based on whiteboard retrospective data of a whiteboard retrospective data object. This may include being based on a whiteboard retrospective template selection element 412 selected.

After generation of the whiteboard retrospective data object, the retrospective application service 120 may transmit and cause rendering of the whiteboard retrospective interface elements on the user device 102 via a user accessed application via a sprint whiteboard interface 500. In various embodiments, one or more portions (e.g., a header) of the sprint whiteboard interface may be called from the embedded application service 116 by the retrospective application service 120 for rendering on a user device 102 via the user-accessed application service. For example, the embedded application service 116 may generate and cause rendering of data associated with a name (e.g., Retrospective: Sprint 5) such that a portion of the data in one or more of the interface elements is first received from the embedded application service 116 and the retrospective application service may generate and cause rendering the remainder of the sprint whiteboard interface.

Whiteboard retrospective data may contain information relating to, without limitation, whiteboard metadata, whiteboard status, whiteboard retrospective tool interface elements 522 (such as lines, shapes, colors, markup, text, sticky notes, icons, images, and charts), whiteboard users, and other data necessary for the proper function of the whiteboard retrospective.

Whiteboard retrospective interface elements 510 are interface elements of the sprint whiteboard interface 500 which display one or more aspects of whiteboard retrospective data. Such aspects include but are not limited to whiteboard retrospective titles, subtitles, headings, footings, owners, users, rows, columns., and the like. In some embodiments, whiteboard retrospective interface elements are generated and located on the whiteboard retrospective by the retrospective application service 120, such as during generation of a whiteboard retrospective data object when a user selected a whiteboard retrospective template selection element 412. In some embodiments, whiteboard retrospective interface elements are generated with a location for their placement on the sprint whiteboard interface 500.

The sprint whiteboard interface 500 enables a user to visualize whiteboard interface elements and modify or edit whiteboard retrospective data to assist with completing a sprint retrospective with their team. In various embodiments, multiple users may all view the sprint whiteboard interface 500 in real-time so that each user may be present with the whiteboard retrospective simultaneously and all edits may be synchronously displayed.

A whiteboard retrospective distribution interface element 502, when rendered, provides a display of an interactive interface element to provide to other users'permission to access, view, and/or edit the sprint whiteboard interface 500 and, thus, the whiteboard retrospective data in the whiteboard retrospective data object. In various objects, on user selection of whiteboard retrospective distribution interface element 502, the service-oriented platform 110 may generate an alert (e.g., notification, email, text) that alerts the user access is being shared to the sharing of the sprint whiteboard interface 500.

A whiteboard retrospective template display options interface element 504, when rendered, provides a display of interactive interface elements enabling a user to access interface element 400 to select a different whiteboard retrospective template selection element 412. The selection of a different whiteboard retrospective template selection element 412 via whiteboard retrospective template display options interface element 504 results in the whiteboard retrospective data object to be modified to include a template structure associated with the template associated with the new whiteboard retrospective template selection element 412 selected.

A whiteboard retrospective template description interface element 506, when rendered, displays sprint data retrieved from the user-accessed application service 112 or embedded application service 116. For example, this sprint data may include a sprint identifier that may be unique and/or associated with the sprint.

One or more whiteboard retrospective category interface elements 510 (e.g., 510A, 510B, 510C and 510D) may be associated with a particular template selected via the whiteboard retrospective template selection element 412. For example, FIG. 5 illustrates four whiteboard retrospective category interface elements 510A, 510B, 510C, and 510D that may be associated with a seventh whiteboard retrospective template selection element 412G may be associated with 4 L's retrospective template.

In various embodiments, each of the one or more whiteboard retrospective category interface elements 510 may be associated with one or more portions of the sprint whiteboard interface 500. Placement of one or more whiteboard retrospective tool interface elements, such as selected via the whiteboard retrospective toolbar interface element 520, may be within the portion of the sprint whiteboard interface 500 associated with a whiteboard retrospective category interface element 510. On such placement, the whiteboard retrospective data object may be modified and/or updated to associate whiteboard retrospective data associated with the whiteboard retrospective tool interface elements to include a whiteboard retrospective category identifier associated with the whiteboard retrospective category interface element 510. In this way, a user may place or move a whiteboard retrospective tool interface elements among the various whiteboard retrospective category interface elements 510 while having a retrospective with other team members while the service-oriented platform 110 dynamically modifies the whiteboard retrospective data object in view of user actions.

A whiteboard retrospective toolbar interface element 520 displays a plurality of whiteboard retrospective tool interface elements that a user may select via the plurality of whiteboard retrospective toolbar tool interface elements 522 to modify the sprint whiteboard interface 500 when conducting a sprint retrospective. Whiteboard retrospective toolbar tool interface elements 522A-522D are examples whiteboard retrospective tool interface elements 522.

For example, whiteboard retrospective toolbar tool interface elements 522A is an interactive interface element associated with a whiteboard retrospective tool interface element of a sticky note. Selection of the whiteboard retrospective toolbar tool interface element 522A allows for a user to place a sticky note on the sprint whiteboard interface 500, including to provide text associated with the sticky note.

As another example, whiteboard retrospective toolbar tool interface elements 522B is an interactive interface element associated with a whiteboard retrospective tool interface element of a text box. Selection of the whiteboard retrospective toolbar tool interface element 522B allows for a user to place a text box on the sprint whiteboard interface 500, including to provide text associated with the text box.

As another example, whiteboard retrospective toolbar tool interface elements 522C is an interactive interface element associated with a whiteboard retrospective tool interface element of shape. Selection of the whiteboard retrospective toolbar tool interface element 522C allows for a user to place a shape on the sprint whiteboard interface 500, including to provide text associated with the shape.

As another example, whiteboard retrospective toolbar tool interface elements 522D is an interactive interface element associated with a whiteboard retrospective tool interface element of line. Selection of the whiteboard retrospective toolbar tool interface element 522D allows for a user to place a line on the sprint whiteboard interface 500, including to provide text associated with the line.

In various embodiments, the whiteboard retrospective toolbar interface element 520 allows for one or more users to select whiteboard retrospective toolbar tool interface elements 522 associated with tools for conducting a sprint retrospective. Thus, the users may create, among other things, graphical depictions of sticky notes, text, shapes, and lines allowing uses to mark up the sprint retrospective interface 500. In various embodiments, the whiteboard retrospective tool interface elements 522 may be customized by a user or group of users, such as changing aspects including but not limited to color, size, font, font size, font color, and location.

Actions taken by a user with the whiteboard retrospective tool interface elements 522 via whiteboard retrospective toolbar interface element 520 are detected by a user-accessed application 112, which transmits a whiteboard retrospective toolbar interface element indication to the service 120.

Upon receipt of a whiteboard retrospective toolbar interface element indication, the service 120 modifies the whiteboard retrospective data of the whiteboard retrospective data object to reflect the changes made by the user to the whiteboard sprint retrospective. An updated whiteboard retrospective data object is transmitted to an embedded application 116 for storage in an embedded application data repository 118. The embedded application 116 generates an updated sprint whiteboard interface 500 based on the updated whiteboard retrospective data, including data regarding the whiteboard retrospective interface elements 510, and whiteboard retrospective tool interface elements 522 and transmit it to the user-accessed application 112 for synchronous rendering on a plurality of user devices 102, wherein each user device 102 is associated with a user-accessed application 112 associated with a user that has permission to access the whiteboard sprint retrospective.

Updates made to the sprint whiteboard interface 500 by any user with permission to access is detected by the user-accessed application 112. User-accessed application 112 transmits a whiteboard retrospective update indication to the retrospective application service 120.

On receiving a whiteboard retrospective update indication, the retrospective application service 120 modifies the whiteboard retrospective data of the whiteboard retrospective data object with the update to reflect the changes made by a user.

In various embodiments, an updated whiteboard retrospective data object is transmitted to an embedded application 116 for storage in an embedded application data repository 118. The embedded application 116 transmits the updated whiteboard retrospective data, including data regarding the whiteboard retrospective interface elements 510, and whiteboard retrospective tool interface elements 522 to the user-accessed application 112 for synchronous rendering on a plurality of user devices 102, wherein each user device 102 is associated with a user-accessed application 112 associated with a user that has permission to access the whiteboard sprint retrospective.

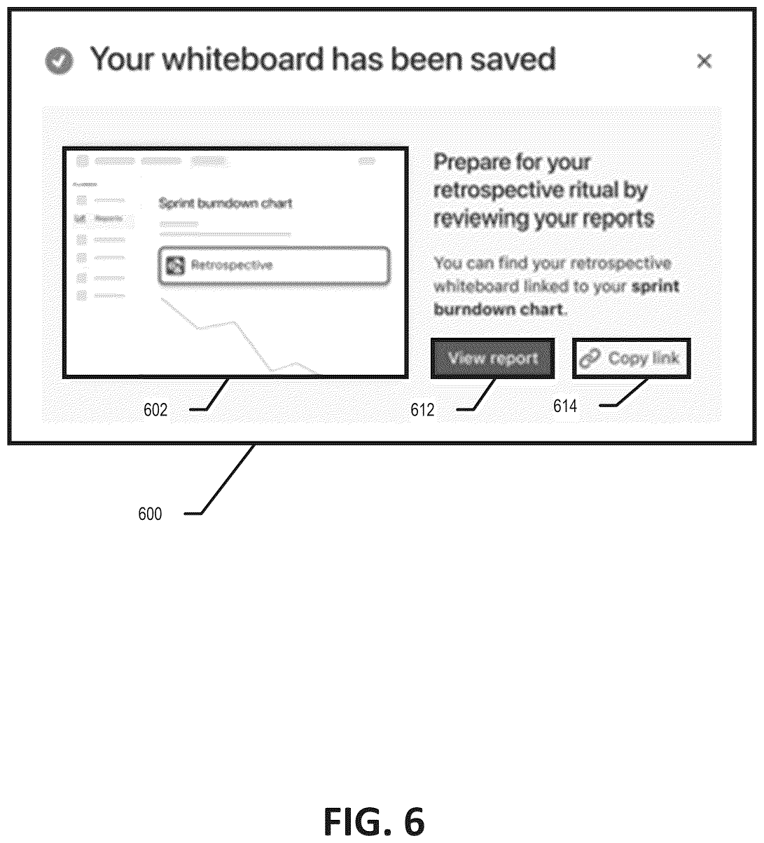

FIG. 6 illustrates an example whiteboard retrospective verification interface element in accordance with one or more embodiments of the present disclosure. In various embodiments, a whiteboard retrospective verification interface element 600 may include a retrospective integration interface element 602, a retrospective inspection interface element 612, and a retrospective sharing interface element 614. In various embodiments, a user-accessed application may render the whiteboard retrospective verification interface element 600 over one or more portions of a sprint interface rendered on a user device 102. Alternatively, in various embodiments, a user-accessed application may render the whiteboard retrospective verification interface element 600 as an interface rendered on a user device 102.

The whiteboard retrospective verification interface element 600 may be rendered to a user via a user-accessed application when the user closes the sprint whiteboard interface 500. For example, after successful creation of a whiteboard retrospective data object and exiting of a display of a sprint whiteboard interface 500, the retrospective application service 120 may generates the whiteboard retrospective verification interface element 600 and transmit it to a user-accessed application 112 for rendering on a user device 102. Alternatively, and/or additionally, the whiteboard retrospective verification interface element 600 may be transmitted after generation of the whiteboard retrospective data object.

In various embodiments, a whiteboard retrospective verification interface element 600 enables a user to confirm that the whiteboard retrospective data object was generated successfully by the retrospective application service 120 and stored successfully in embedded application data repository 118.

A retrospective integration interface element 602 displays a visualization of a whiteboard retrospective indication interface element is located on a sprint interface. The whiteboard retrospective indication interface element, when selected by a user via a user-accessed application, enables a user to access and view a sprint whiteboard interface 500. The retrospective integration interface element 602 may display a location selected by a user, such as via a sprint retrospective selection interface element 306.

A retrospective inspection interface element 612 displays a user interactive interface element that, on selection, navigates a to a sprint interface.

A retrospective sharing interface element 614 interactive interface element to provide to other users'permission to access, view, and/or edit the sprint whiteboard interface 500 and, thus, the whiteboard retrospective data in the whiteboard retrospective data object.

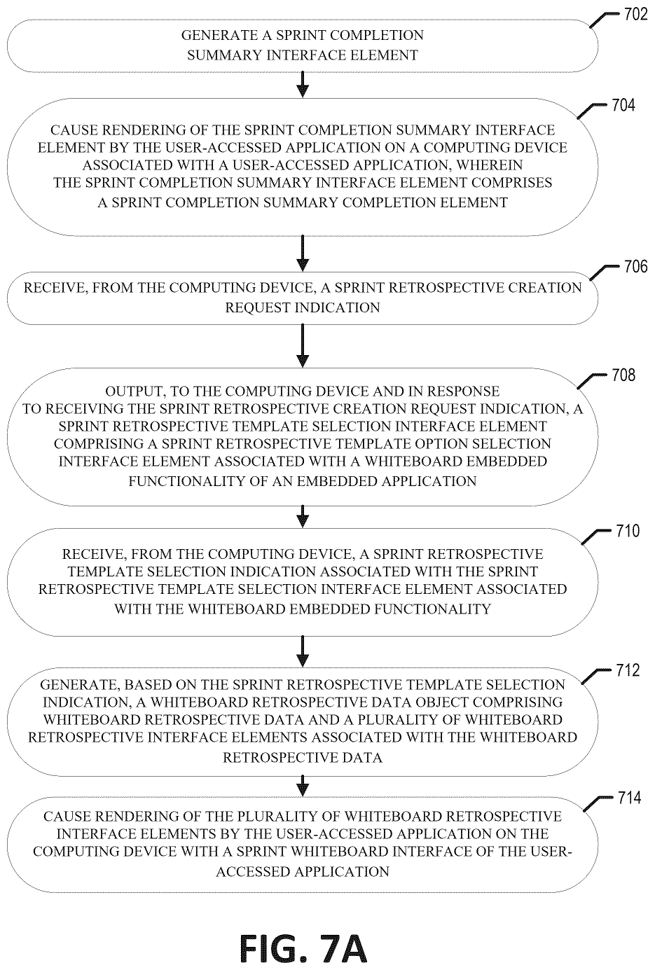

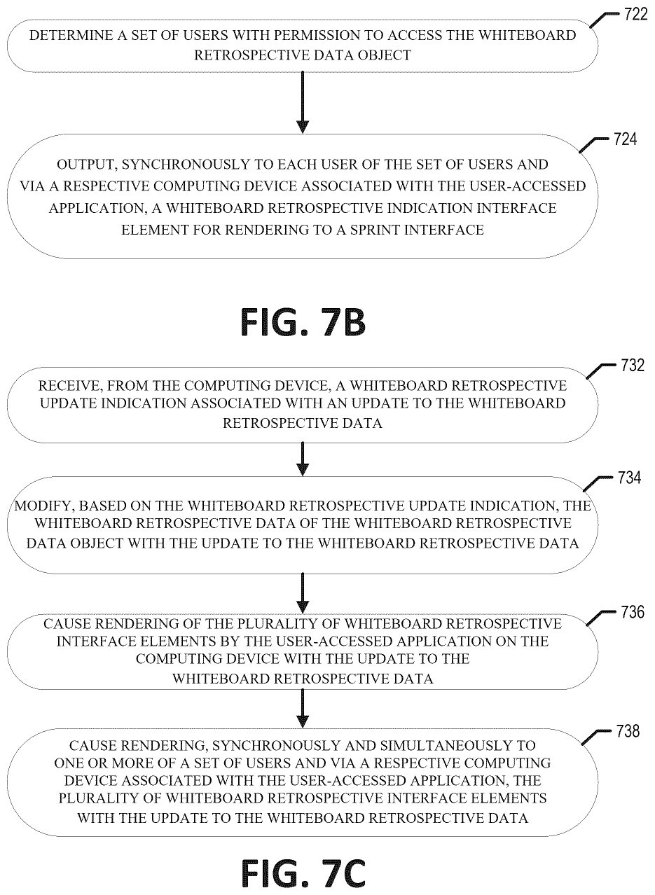

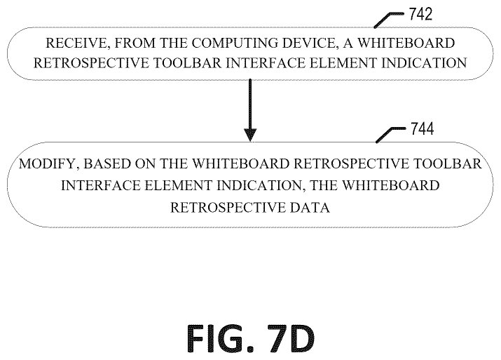

FIG. 7 illustrate a flowcharts of operations for a in accordance with one or more embodiments of the present disclosure. These operations are associated with various functionality of the service-oriented platform 110, including an example flow of operations and interactions between user device 102, user-accessed application service 112, embedded application service 116, and retrospective application service 120.

FIG. 7A illustrates a flowchart of operations for generating a whiteboard retrospective data object and rendering a sprint interface in accordance with one or more embodiments of the present disclosure.

At operation 702, generate a sprint completion summary interface element 200. In various embodiments, the embedded application service 116 may generate a sprint completion summary interface element 200.

At operation 704, cause rendering of the sprint completion summary interface element 200 by the user-accessed application on a user device 102 associated with a user-accessed application, wherein the sprint completion summary interface element 200 comprises a sprint summary retrospective interface element 206. In various embodiments, the rendering may be caused by the user-accessed application service 112 and/or the embedded application service 116.

At operation 706, receive from the user device 102, a sprint retrospective creation request indication. A user may interact with the rendering of the sprint completion summary interface element 200 on the user device 102 to select a sprint summary retrospective interface element 205, which may cause the generation and transmission of a sprint retrospective creation request indication.

At operation 708, output, to the user device 102 and in response to receiving the sprint retrospective creation request indication, a sprint retrospective template selection interface element 300 comprising a sprint retrospective template option selection interface element 304 associated with a whiteboard embedded functionality of an embedded application.

At operation 710, receive from the user device 102, a sprint retrospective template selection indication associated with the sprint retrospective template selection interface element 300 associated with the whiteboard embedded functionality. A user may interact with a rendering of the sprint retrospective template selection interface element 300 on the user device 102 to select a sprint retrospective creation interface element 310, which may cause the generation and transmission of a sprint retrospective template selection indication.

At operation 712, generate, based on the sprint retrospective template selection indication, a whiteboard retrospective data object comprising whiteboard retrospective data and a plurality of whiteboard retrospective interface elements associated with the whiteboard retrospective data. In response to receiving the sprint retrospective template selection indication a retrospective application service 120 may generate the whiteboard retrospective data object.

At operation 714, cause rendering of the plurality of whiteboard retrospective interface elements by the user-accessed application on the user device with a sprint whiteboard interface of the user-accessed application. In various embodiments, the retrospective application service 120 may cause rendering of the whiteboard retrospective interface elements with rendering of a sprint whiteboard interface on the user-accessed application on the user device 102.

FIG. 7B illustrates a flowchart of operations associated with user permissions in accordance one or more embodiments of the present disclosure. In various embodiments, one or more users of user device 102 may be required to have permissions to access the whiteboard retrospective data object, such as to allow for rendering of the sprint whiteboard interface 500 or modifying of the whiteboard retrospective data object.

At operation 722, determine a set of users with permission to access the whiteboard retrospective data object. The service-oriented platform 100, particularly the user-accessed application service 112 and/or embedded application service 116, determine a set of users that have permissions to access the whiteboard retrospective data object. For example, the set of users may have permissions associated with the user-accessed application service 112 but not with the embedded application service 116. Due to the permissions associated with the user-accessed application service 112, the users may be determined to have permissions to the whiteboard retrospective data object with the user-accessed application.

At operation 724, output, synchronously to each user of the set of users and via a respective user device 102 associated with the user-accessed application, a whiteboard retrospective indication interface element 600 for rendering to a sprint interface. Each user may receive a whiteboard retrospective verification interface element 600 to provide that they have access to the whiteboard retrospective data object, such as for viewing via a sprint whiteboard interface 500.

FIG. 7C illustrates a flowchart of operations for modifying whiteboard retrospective data in accordance with one or more embodiments of the present disclosure.

At operation 732, receive, from a user device 102, a whiteboard retrospective update indication associated with an update to the whiteboard retrospective data. One or more users may, via a user-accessed application, make an update, such a via the sprint whiteboard interface 500. This may include, for example, a user adding a sticky note to the sprint whiteboard interface 500 with a whiteboard retrospective toolbar tool interface element 522A. When an update occurs, the user-accessed application may generate a whiteboard retrospective update indication to provide that an update has been made. The whiteboard retrospective update indication is transmitted to the embedded application service 116 and/or retrospective application service 120.

At operation 734, modify, based on the whiteboard retrospective update indication, the whiteboard retrospective data of the whiteboard retrospective data object with the update to the whiteboard retrospective data. The embedded application service 116 and/or retrospective application service 120 may modify the whiteboard retrospective data in the whiteboard retrospective data object based on the whiteboard retrospective update indication.

At operation 736, cause rendering of the plurality of whiteboard retrospective interface elements by the user-accessed application on the user device with the update to the whiteboard retrospective data. After the whiteboard retrospective data object has been updated, the service-oriented platform 110, such as via the user-accessed application service 112, embedded application service 116, and/or retrospective application service 120, causes rendering of update with the rendering of a plurality of whiteboard retrospective interface elements that include the update.

At operation 738, cause rendering, synchronously and simultaneously to one or more of a set of users and via a respective user device associated with the user-accessed application, the plurality of whiteboard retrospective interface elements with the update to the whiteboard retrospective data. In various embodiments with multiple users utilizing the sprint whiteboard interface simultaneously, the service-oriented platform 110, causes the rendering of the update to occur synchronously and simultaneously for each of a set of users that are using the sprint whiteboard interface.

FIG. 7D illustrates a flowchart of operations for a whiteboard retrospective toolbar interface element in accordance with one or more embodiments of the present disclosure.

At operation 742, receive, from the user device, a whiteboard retrospective toolbar interface element indication. A user of a user-accessed application on a user device 102 may be viewing the sprint whiteboard interface 500 and modify the whiteboard retrospective by interacting with one or more whiteboard retrospective toolbar tool interface elements 522 to perform a retrospective. When a whiteboard retrospective toolbar tool interface element 522 is selected the user-accessed application on the user device 102 generates and transmits a whiteboard retrospective toolbar interface element indication to the service oriented platform 110, which receives the whiteboard retrospective toolbar interface element indication associated with the change or update the user is making.

At operation 744, modify, based on the whiteboard retrospective toolbar interface element indication, the whiteboard retrospective data. The service-oriented platform 110, such as the embedded application service 116 and/or retrospective application service 120, modify the whiteboard retrospective data in a whiteboard retrospective data object with the update indicated by the whiteboard retrospective toolbar interface element indication.

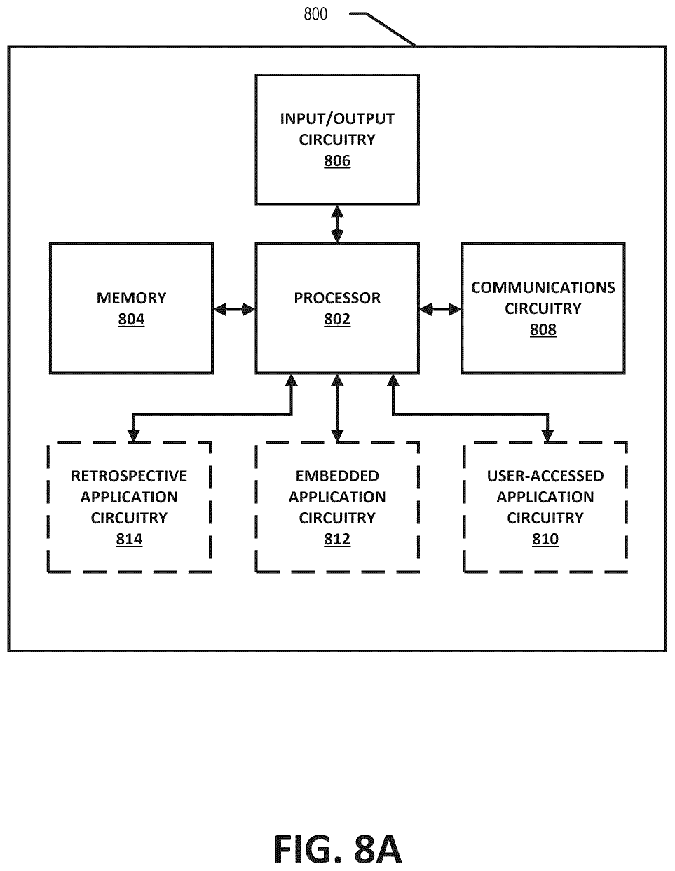

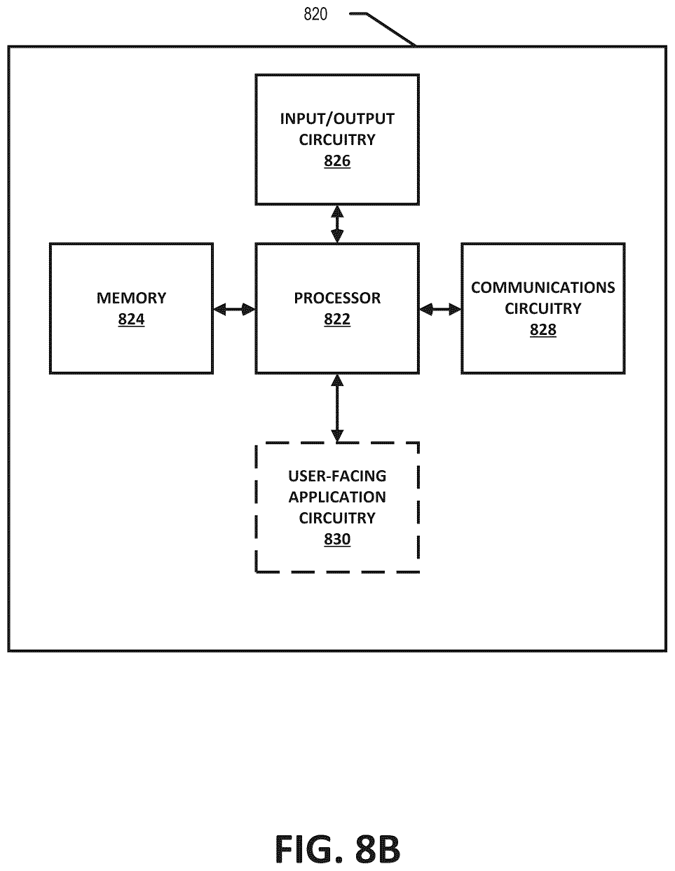

FIGS. 8A and 8B illustrate example computing systems in accordance with one or more embodiments of the present disclosure. A computing system 800 of FIG. 8A may be a system associated with the service-oriented platform 110 include a processor 802, memory 804, input/output circuitry 806, communications circuitry 808, retrospective component circuitry 810, embedded application circuitry 812 and user-accessed application circuitry 814.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” may be understood to include a single core processor, a multi-core processor, multiple processors internal to the embedded application communication apparatus 200, and/or one or more remote or “cloud” processor(s) external to the embedded application communication apparatus 200.

The apparatus 800 may include processor 802, memory 804, input/output circuitry 806, communications circuitry 808, user-accessed application circuitry 810, embedded application circuitry 812, and retrospective component circuitry 814. The apparatus 800 may be configured to execute the operations described herein. Although these components (e.g., processor 802, memory 804, etc.) are described with respect to functional limitations, it should be understood that the particular implementations necessarily include the use of particular hardware, software, and/or firmware. It should also be understood that certain of these components (e.g., processor 802, memory 804, etc.) may include similar or common hardware. For example, two or more sets of circuitry may both leverage use of the same processor, network interface, storage medium, video card, motherboard, or the like to perform their associated functions, such that duplicate hardware is not required for each individual set of circuitry.

The processor 802 (and/or co-processor or any other processing circuitry assisting or otherwise associated with the processor) may be in communication with the memory 804 via a bus for passing information among components of the apparatus. The memory 804 is non-transitory and may include, for example, one or more volatile and/or non-volatile memories. In other words, for example, the memory 804 may be an electronic storage device (e.g., a computer-readable storage medium). The memory 804 may be configured to store information, data, content, applications, instructions, or the like for enabling the apparatus to carry out various functions in accordance with example embodiments of the present disclosure.

The processor 802 may be embodied in a number of different ways and may, for example, include one or more processing devices configured to perform independently. The processor 802 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud”processors.

The processor 802 may be configured to execute instructions stored in the memory 804 or otherwise accessible to the processor 802. The processor 802 may be configured to execute hard-coded functionalities. As such, whether configured by hardware or software methods, or by a combination thereof, the processor 802 may represent an entity (e.g., physically embodied in circuitry) capable of performing operations according to an embodiment of the present disclosure while configured accordingly. Alternatively, as another example, when the processor 802 is embodied as an executor of software instructions, the instructions may specifically configure the processor 802 to perform the algorithms and/or operations described herein when the instructions are executed.

The apparatus 800 may include input/output circuitry 806 that may, in turn, be in communication with processor 802 to provide output to the user and, in some embodiments, to receive an indication of a user input. The input/output circuitry 806 may comprise a user interface and may include a display, and may comprise a web user interface, a mobile application, a query-initiating user device, a kiosk, or the like. In some embodiments, the input/output circuitry 806 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 804, an accessible repository, and/or the like).

The communications circuitry 808 may be any means such as a device or circuitry embodied in either hardware or a combination of hardware and software that is configured to receive and/or transmit data from/to a network and/or any other device, circuitry, or module in communication with the apparatus 800. In this regard, the communications circuitry 808 may include, for example, a network interface for enabling communications with a wired or wireless communication network. For example, the communications circuitry 808 may include one or more network interface cards, antennae, buses, switches, routers, modems, and supporting hardware and/or software, or any other device suitable for enabling communications via a network. Additionally or alternatively, the communications circuitry 808 may include the circuitry for interacting with the antenna/antennae to cause transmission of signals via the antenna/antennae or to handle receipt of signals received via the antenna/antennae.

The user-accessed application circuitry 810 includes hardware, software, or a combination thereof, configured to support various user-accessed application functionality provided by a user-facing application. In some embodiments, the user-accessed application circuitry 810 utilizes processing circuitry, such as the processor 802, to perform one or more of such actions. For example, in some embodiments, the user-accessed application circuitry 810 includes hardware, software, firmware, and/or a combination thereof, that initializes a user-accessed application on a user device 102, initiates via the user-accessed application a connection with an embedded application, identifies at least one data object that is maintained by an embedded application, and causes rendering of an integrated interface associated with the user-accessed application, the integrated interface comprising a representation of at least a portion of the data object. Additionally or alternatively, in some embodiments, the user-accessed application circuitry 810 includes hardware, software, firmware, and/or a combination thereof, that provides interaction with an embedded application. In some embodiments, for example, the user-accessed application circuitry 810 facilitates one or more of the actions or operations described herein.

The embedded application circuitry 812 includes hardware, software, or a combination thereof, configured to support accessing and/or otherwise providing various embedded application functionality. In some embodiments, the embedded application circuitry 812 utilizes processing circuitry, such as the processor 802, to perform one or more of such actions or operations. Alternatively or additionally, in some embodiments, the embedded application circuitry 812 includes hardware, software, firmware, and/or a combination thereof, that maintains one or more embedded data object, which may be accessed by a user-accessed application as described herein. In some embodiments, for example, the embedded application circuitry 812 facilitates one or more of the actions or operations described herein with respect to the embedded application service 116. It should be appreciated that, in some embodiments, embedded application circuitry 812 may include a separate processor, specially configured field programmable gate array (FPGA), or a specially programmed application specific integrated circuit (ASIC).

The retrospective application circuitry 814 includes hardware, software, or a combination thereof, configured to support accessing and/or otherwise providing various retrospective application functionality. In some embodiments, the retrospective application circuitry 814 utilizes processing circuitry, such as the processor 802, to perform one or more of such actions or operations. Alternatively or additionally, in some embodiments, the retrospective application circuitry 814 includes hardware, software, firmware, and/or a combination thereof, that maintains one or more embedded data object, which may be accessed by a user-accessed application as described herein. In some embodiments, for example, retrospective application circuitry 814 facilitates one or more of the actions or operations described herein with respect to the retrospective application service 120. It should be appreciated that, in some embodiments, retrospective application circuitry 814 may include a separate processor, specially configured field programmable gate array (FPGA), or a specially programmed application specific integrated circuit (ASIC).

It should be appreciated that, in some embodiments, one or more of the sets of circuitry 802-814 are combinable. Alternatively or additionally, in some embodiments, one or more of the modules performs some or all of the functionality described associated with another component. For example, in some embodiments, the sets of circuitry 810, 812, and 814 are combined into a single module embodied in hardware, software, firmware, and/or a combination thereof. Similarly, in some embodiments, one or more of the sets of circuitry 810, 812, and/or 814 are combined such that the processor 802 performs one or more of the operations described above with respect to each of these modules.

A user device 820 of FIG. 8B may be a user device 102 and include a processor 802, memory 804, input/output circuitry 806, communications circuitry 808, and user-facing application circuitry 820.

The computing system 820 may be a user device 102. The computing system 820 may include processor 822, memory 824, input/output circuitry 826, communications circuitry 828, and user-facing application circuitry 830. Although these components (e.g., processor 822, memory 824, etc.) are described with respect to functional limitations, it should be understood that the particular implementations necessarily include the use of particular hardware, software, and/or firmware. It should also be understood that certain of these components (e.g., processor 822, memory 824, etc.) may include similar or common hardware. For example, multiple sets of circuitry may both leverage use of the same processor, network interface, storage medium, or the like to perform their associated functions, such that duplicate hardware is not required for each set of circuitry. Apparatus 820 may also be configured to leverage, at least partially, one or more hardware components described above with respect to apparatus 800. For example, apparatus 820 may further comprise one or more of processor 802, memory 804, input/output circuitry 806, and communications circuitry 828.

The user-facing application circuitry 830 includes hardware, software, firmware, and/or a combination thereof, that supports client-facing functionality of the user device 102 for interacting with a user-accessed application and/or associated embedded application(s) described herein. In some embodiments, the user-facing application circuitry 830 utilizes processing circuitry, such as the processor 222, to perform one or more of these actions or operations. In some embodiments, the user-facing application circuitry 830 includes hardware, software, firmware, and/or a combination thereof, that initializes a user-accessed application and connection associated with a corresponding embedded application. An example connection (e.g., a data driven connection) between an example user-accessed application and an embedded application is described in commonly owned U.S. Pat. No. 11,044,348 that was filed Nov. 5, 2020 and is entitled “System, Method, And Computer Program Product For Improved Embedded Application Data Management”, and which is hereby incorporated by reference in its entirety.

Additionally or alternatively, in some embodiments, the user-facing application circuitry 830 includes hardware, software, firmware, and/or a combination thereof, that provides one or more user interfaces to enable access to various functionality associated with the user-accessed application and/or the embedded application from within the user-accessed application. Additionally or alternatively still, in some embodiments, the user-facing application circuitry 830 includes hardware, software, firmware, and/or a combination thereof, that enables download, installation, and/or initializing of a separate application associated with the embedded application.

In this regard, it should be appreciated that in such embodiments the user-facing application circuitry 860 enables access to functionality associated with both the user-accessed application and the embedded application from within a single user-facing application executed and/or otherwise accessed via the user device 102. In some embodiments, the user-facing application circuitry 830 performs one or more of such actions or operations via communication with one or more application services, for example a user-accessed application data repository 114 and/or retrospective application service 120. It should be appreciated that, in some embodiments, the user-facing application circuitry 830 may include a separate processor, specially configured FPGA, or a specially programmed ASIC.

It should be readily appreciated that the embodiments of the systems and apparatuses, described herein may be configured in various additional and alternative manners in addition to those expressly described herein.

### CONCLUSION

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

1. An apparatus comprising at least one processor and at least one non-transitory memory including computer-coded instructions thereon, the computer coded instructions, with the at least one processor, configure the apparatus to:
receive, from a user device associated with a user-accessed application, a sprint retrospective creation request indication;
output, to the user device and in response to receiving the sprint retrospective creation request indication, a sprint retrospective template selection interface element comprising a sprint retrospective template option selection interface element associated with a whiteboard embedded functionality of an embedded application;
receive, from the user device, a sprint retrospective template selection indication associated with the sprint retrospective template selection interface element associated with the whiteboard embedded functionality;
generate, based on the sprint retrospective template selection indication, a whiteboard retrospective data object comprising whiteboard retrospective data and a plurality of whiteboard retrospective interface elements associated with the whiteboard retrospective data; and
cause rendering of the plurality of whiteboard retrospective interface elements by the user-accessed application on the user device with a sprint whiteboard interface of the user-accessed application.

2. The apparatus of claim 1, wherein the computer coded instructions are further configured to, with the at least one processor, cause the apparatus to:
generate, prior to receiving the sprint retrospective creation request indication, a sprint completion summary interface element;
cause rendering of the sprint completion summary interface element by the user-accessed application on the user device, wherein the sprint completion summary interface element comprises a sprint completion indication interface element; and
wherein the sprint retrospective creation request indication is associated with detection of a user selection of the sprint completion indication interface element.

3. The apparatus of claim 1, wherein the computer coded instructions are further configured to, with the at least one processor, cause the apparatus to:
determine a set of users with permission to access the whiteboard retrospective data object; and
output, synchronously to each user of the set of users and via a respective user device associated with the user-accessed application, a whiteboard retrospective indication interface element for rendering to a sprint interface.

4. The apparatus of claim 1, wherein the computer coded instructions are further configured to, with the at least one processor, cause the apparatus to:
receive, from the user device, a whiteboard retrospective update indication associated with an update to the whiteboard retrospective data;
modify, based on the whiteboard retrospective update indication, the whiteboard retrospective data of the whiteboard retrospective data object with the update to the whiteboard retrospective data; and
cause rendering of the plurality of whiteboard retrospective interface elements by the user-accessed application on the user device with the update to the whiteboard retrospective data.

5. The apparatus of claim 4, wherein the computer coded instructions are further configured to, with the at least one processor, cause the apparatus to:
cause rendering, synchronously and simultaneously to one or more of a set of users and via a respective user device associated with the user-accessed application, the plurality of whiteboard retrospective interface elements with the update to the whiteboard retrospective data.

6. The apparatus of claim 1, wherein the sprint whiteboard interface is comprised of a whiteboard retrospective toolbar interface element comprised of a plurality of whiteboard retrospective tool interface elements.

7. The apparatus of claim 6, wherein the computer coded instructions are further configured to, with the at least one processor, cause the apparatus to:
receive, from the user device, a whiteboard retrospective toolbar interface element indication; and
modify, based on the whiteboard retrospective toolbar interface element indication, the whiteboard retrospective data.

8. A computer-implemented method comprising:
receiving, from a user device associated with a user-accessed application, a sprint retrospective creation request indication;
outputting, to the user device and in response to receiving the sprint retrospective creation request indication, a sprint retrospective template selection interface element comprising a sprint retrospective template option selection interface element associated with a whiteboard embedded functionality of an embedded application;
receiving, from the user device, a sprint retrospective template selection indication associated with the sprint retrospective template selection interface element associated with the whiteboard embedded functionality;
generating, based on the sprint retrospective template selection indication, a whiteboard retrospective data object comprising whiteboard retrospective data and a plurality of whiteboard retrospective interface elements associated with the whiteboard retrospective data, wherein the whiteboard retrospective interface elements include at least one whiteboard retrospective category interface element; and
causing rendering of the plurality of whiteboard retrospective interface elements by the user-accessed application on the user device with a sprint whiteboard interface of the user-accessed application.

9. The computer-implemented method of claim 8, further comprising:
generating, prior to receiving the sprint retrospective creation request indication, a sprint completion summary interface element;
causing rendering of the sprint completion summary interface element by the user-accessed application on the user device, wherein the sprint completion summary interface element comprises a sprint completion indication interface element; and
wherein the sprint retrospective creation request indication is associated with detection of a user selection of the sprint completion indication interface element.

10. The computer-implemented method of claim 8, further comprising:
determining a set of users with permission to access the whiteboard retrospective data object; and
outputting, synchronously to each user of the set of users and via a respective user device associated with the user-accessed application, a whiteboard retrospective indication interface element for rendering to a sprint interface.

11. The computer-implemented method of claim 8, further comprising:
receiving, from the user device, a whiteboard retrospective update indication associated with an update to the whiteboard retrospective data;
modifying, based on the whiteboard retrospective update indication, the whiteboard retrospective data of the whiteboard retrospective data object with the update to the whiteboard retrospective data; and
causing rendering of the plurality of whiteboard retrospective interface elements by the user-accessed application on the user device with the update to the whiteboard retrospective data.

12. The computer-implemented method of claim 11, further comprising:
causing rendering, synchronously and simultaneously to one or more of a set of users and via a respective user device associated with the user-accessed application, the plurality of whiteboard retrospective interface elements with the update to the whiteboard retrospective data.

13. The computer-implemented method of claim 8, wherein the sprint whiteboard interface is comprised of a whiteboard retrospective toolbar interface element comprised of a plurality of whiteboard retrospective tool interface elements.

14. The computer-implemented method of claim 13, further comprising:
receiving, from the user device, a whiteboard retrospective toolbar interface element indication; and
modifying, based on the whiteboard retrospective toolbar interface element indication, the whiteboard retrospective data.

15. A computer program product comprising at least one non-transitory computer-readable storage medium having computer-readable program code portions stored therein, the computer-readable program code portions configured to:
receive, from a user device associated with a user-accessed application, a sprint retrospective creation request indication;
output, to the user device and in response to receiving the sprint retrospective creation request indication, a sprint retrospective template selection interface element comprising a sprint retrospective template option selection interface element associated with a whiteboard embedded functionality of an embedded application;
receive, from the user device, a sprint retrospective template selection indication associated with the sprint retrospective template selection interface element associated with the whiteboard embedded functionality;
generate, based on the sprint retrospective template selection indication, a whiteboard retrospective data object comprising whiteboard retrospective data and a plurality of whiteboard retrospective interface elements associated with the whiteboard retrospective data, wherein the plurality of whiteboard retrospective interface elements include a whiteboard retrospective toolbar interface element; and
cause rendering of the plurality of whiteboard retrospective interface elements by the user-accessed application on the user device with a sprint whiteboard interface of the user-accessed application.

16. The computer-program product of claim 15, wherein the at least one non-transitory computer-readable storage medium having computer-readable program code portions stored therein, further configure the computer-readable program code portions to:
generate, prior to receiving the sprint retrospective creation request indication, a sprint completion summary interface element;
cause rendering of the sprint completion summary interface element by the user-accessed application on the user device, wherein the sprint completion summary interface element comprises a sprint completion indication interface element; and
wherein the sprint retrospective creation request indication is associated with detection of a user selection of the sprint completion indication interface element.

17. The computer-program product of claim 15, wherein the at least one non-transitory computer-readable storage medium having computer-readable program code portions stored therein, further configure the computer-readable program code portions to:
determine a set of users with permission to access the whiteboard retrospective data object; and
output, synchronously to each user of the set of users and via a respective user device associated with the user-accessed application, a whiteboard retrospective indication interface element for rendering to a sprint interface.

18. The computer-program product of claim 15, wherein the at least one non-transitory computer-readable storage medium having computer-readable program code portions stored therein, further configure the computer-readable program code portions to:
receive, from the user device, a whiteboard retrospective update indication associated with an update to the whiteboard retrospective data;
modify, based on the whiteboard retrospective update indication, the whiteboard retrospective data of the whiteboard retrospective data object with the update to the whiteboard retrospective data; and
cause rendering of the plurality of whiteboard retrospective interface elements by the user-accessed application on the user device with the update to the whiteboard retrospective data.

19. The computer-program product of claim 15, wherein the sprint whiteboard interface is comprised of a whiteboard retrospective toolbar interface element comprised of a plurality of whiteboard retrospective tool interface elements.

20. The computer-program product of claim 19, wherein the at least one non-transitory computer-readable storage medium having computer-readable program code portions stored therein, further configure the computer-readable program code portions to:
receive, from the user device, a whiteboard retrospective toolbar interface element indication; and
modify, based on the whiteboard retrospective toolbar interface element indication, the whiteboard retrospective data.
